(19) United States
(12) Patent Application Publication
(10) Pub. No.: US 2005/0133303 A1
(43) Pub. Date: Jun. 23, 2005

(54) Safety belt device having warning device

(76) Inventor: Samuel Wen-Chih Hsu, Taoyuan (TW)

Correspondence Address: DENNISON, SCHULTZ, DOUGHERTY & MACDONALD, 1727 KING STREET, SUITE 105, ALEXANDRIA, VA, 22314, US

(21) Appl. No.: 11/037,209

(22) Filed: Jan. 19, 2005

Related U.S. Application Data
(63) Continuation-in-part of application No. 10/702,788, filed on Nov. 4, 2003.

(51) Int. Cl. E06C 5/34

(52) U.S. Cl. 182/18; 340/687

(57) ABSTRACT

A safety belt device is used for coupling users to support members and to suspend and space the users from the ground when the users fell out of the support members, it comprises a buffer device capable of peeling off one piece after another to extended, and a warning device capable of delivering warning signals when said buffer device is peeling off one piece after another.

### BACKGROUND OF THE INVENTION

1. Field of the invention

The present invention relates to a safety belt device, and more particularly to a safety belt device having a warning device for generating signals automatically when accidents happened.

2. Description of the Prior Art

For protecting workers who are working at high elevations or buildings or architectures, safety nets will be attached to the lower portion of the buildings or architectures, for supporting the workers fell from the buildings or architectures, and for preventing the workers from directly fell down to the ground.

In addition to the safety nets, various kinds of safety belts have also been developed to be hooked or secured between the workers and the buildings or architectures, to suspend the workers and to prevent the workers from directly fell down to the ground when accidents happened.

Normally, the typically safety belts comprise two hooks or latches attached to the end thereof, for hooking or securing to the workers and the buildings or architectures respectively, and to suspend and space the workers from the ground when the workers fell out of the buildings or architectures inadvertently. However, in some of the accidents, when the workers fell out of the buildings or architectures and suspended at high levels by the safety belts, the workers may be unconscious and may not ask help from others.

The U.S. Pat. No. 4,253,544 discloses a safety belt device having warning device, it comprises a warning device having a flag deposited in a box, when accident happens, the flag will automatically stream in the air so as to attract the attention of people, and attain the effect of warning. However, the skill of using the flag to be streamed in the air can not be inspected by people all the time, especially when the sky is dark.

The Japanese patent publication JP10-277172 discloses a safety belt device having warning device, it comprises a warning device capable of delivering warning sound, the warning device contains an insulating plate to be inserted between two batteries, the other end of the insulating plate connected to a pulling rope. When accident happens, the pulling rope will pull the insulating plate out of the position between two batteries and then the warning device is conducted. However this kind of safety belt device has the disadvantages that is the insulating plate is easy to fall down and causes unnecessary alarm.

The present invention has arisen to mitigate and/or obviate the afore-described disadvantages of the conventional safety belts.

### SUMMARY OF THE INVENTION

The main object of the present invention is to provide a safety belt device having a warning device for generating signals automatically when accidents happened, so as to obtain the first time of saving the worker's life.

Another object of the present invention is to provide a safety belt device having warning device, it contains a buffer belt and a actuator pin for actuating the warning device to deliver warning signal; wherein, the initiator pin has one end to be inserted to the ON/OFF switch of warning device, and another end to be connected to a pulling rope with designated length, another end of said pulling rope is then connected to the end surface of said buffer belt. Thus, when accident happens, since the user is falling downward, due to the pulling force, the buffer belt then extended one face by another face, said actuator pin then is pulled out of the warning device, and the warning device is actuated, so that the function of automatically delivering warning signal on the time when accidents happened is achieved.

### BRIEF DESCRIPTION OF THE DRAWINGS

FIG. 1 is a partial plan schematic view illustrating the operation of a safety belt device in accordance with the present invention, for supporting workers at high elevation;

FIG. 2 is a perspective view of the safety belt device;

FIG. 3 is a partial plan schematic view illustrating a buffer device and a warning device on the safety belt device; and

FIG. 4 is a drawing showing the buffer device and warning device of the present invention before accidents happened; and

FIG. 5 is a drawing showing the buffer device and warning device of the present invention after accidents happened and the buffer device is extended.

### DETAILED DESCRIPTION OF THE PREFERRED EMBODIMENT

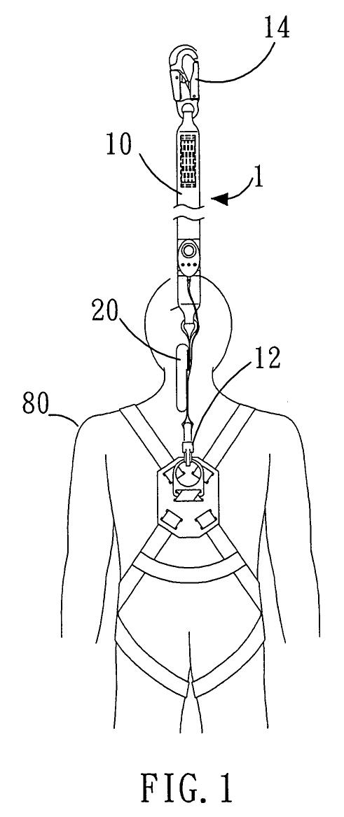

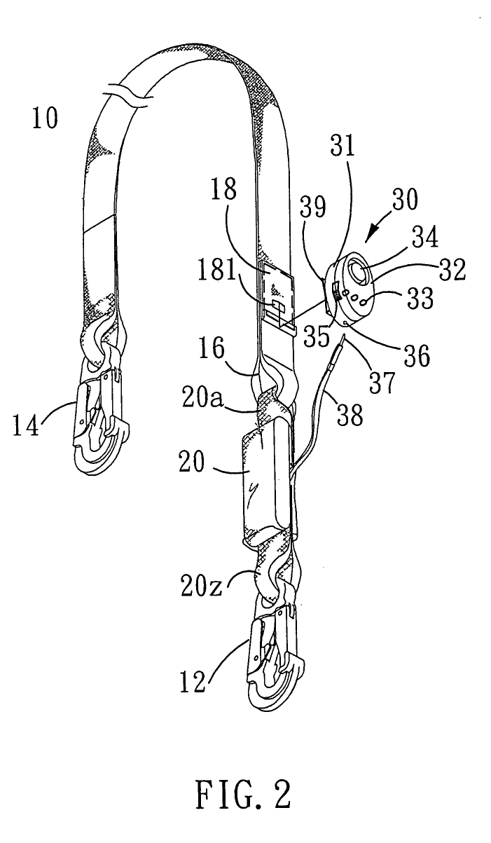

Refer to the drawings, the initially to FIG. 1 and FIG. 2, a safety belt device in accordance with the present invention is generally indicated with a reference numeral “1” and comprises a belt body 10 including a fastener member 12, such as a latch or hook provided on one end for attaching to the worker 80 (FIG. 1), and another fastener member 14 provided on the other end for attaching to supporting members, such as the buildings or architectures, etc. (not shown).

The fastener members 12, 14 may be hooked or attached to the supporting members for suspending the worker 80 from the ground or for preventing the worker 80 from directly fell down to the ground when accident is happened.

A clamp portion 18 provided onto the surface of belt body 10, it is connected with the belt body 10 by its outer edges so that a space is formed inside the clamp portion, and there is a hole 181 formed on the surface of clamp portion 18.

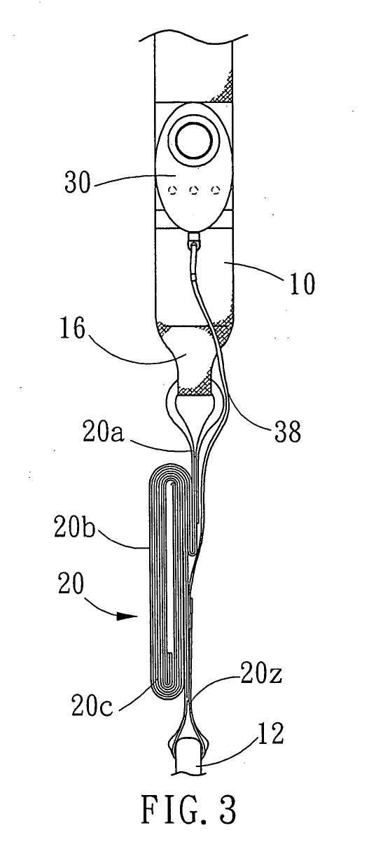

Please also refer to FIG. 3, there is a buffer belt 20 made of nylon or plastics, it has a plurality of buffer units 20a. 20b. 20c . . . 20z, the buffer units 20a. 20b. 20c . . . 20z are connected each others firstly and are bent each others, then finally, sawed together to formed a whole body of buffer device so that when the buffer device is pulled, it will be extended and peeled one piece by another, thus obtain a long extended buffer device 20. Wherein, the first buffer unit 20a is connected to one end 16 of belt body 10, the last buffer unit 20z is connected to one end of fastener members 12.

A warning device 30 is capable of generating warning signals to ask help from others when accidents happened. It is composed of a body 31 and a cover 32. On the body 31, there are a set of LED alarm lamps 33 and a buzzer 34, said cover 32 is made of light-penetrated materials. There is a switch 35 formed on one side of the body 31, there is also a rocket 36 formed on its bottom, said rocket 36 is provided for insertion of metallic actuator pin 37, while the another end of the actuator pin 37 is connected to a pulling rope 38, another end of pulling rope 38 is then connected to the surface of the last buffer unit 20z; And, there is a clip board 39 provided on the back of the body 31, so that the warning device 30 can be inserted into the hole 181 on the clamp portion 18 and then fixed onto the belt body 10.

The actuator pin 37 of the warning device 30 is arranged to actuated or operated when the buffer device 20 is extended or stretched.

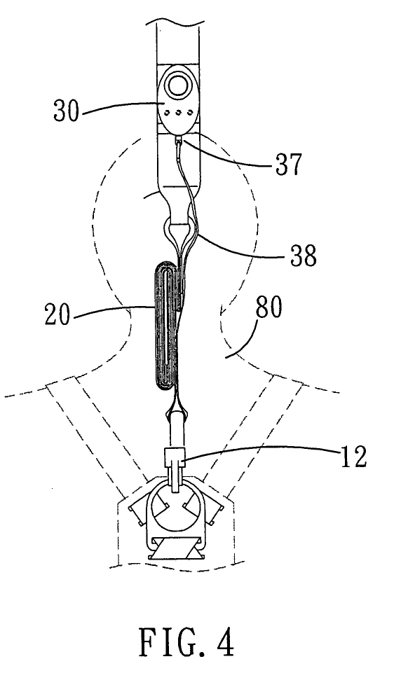

In using the present invention, as shown in FIG. 4, the fastener member 12 near the buffer device 20 is provided for attaching to the worker 80 (FIG. 1), another fastener member 14 provided on the other end for attaching to the supporting members, such as the buildings or architectures.

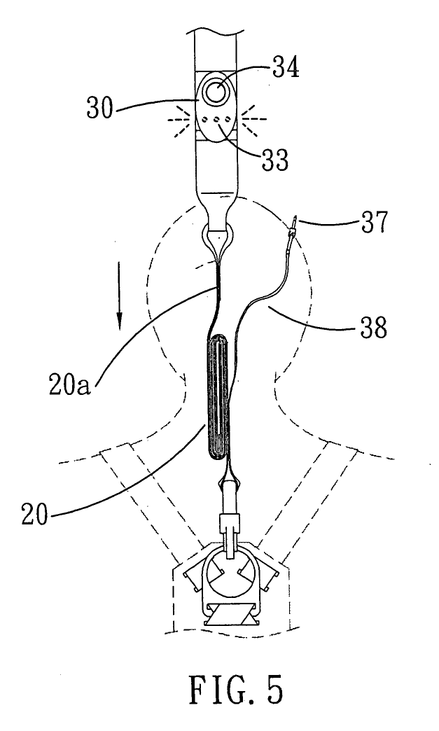

At this moment, one end of the metallic actuator pin 37 connects to the pulling rope 38, and its another end is inserted into the rocket 36 formed at the bottom of the warning device 30, because the warning device is in “OFF” state, it would not deliver alarm signals; when accident happens, and the worker is falling down, as shown in FIG. 5, the buffer units 20a. 20b.20c . . . 20z of buffer device 20 shall be peeled one piece after another due to the falling gravity of worker. When the first buffer unit 20a is peeled off from the buffer device 20, due to the fixed length of pulling rope 38, and due to one end of the pulling rope 38 is fixed to the last buffer unit 20z, the metallic actuator pin 37 shall be pulled downward by the pulling rope 38, and separates away from the rocket 36. Then the ON/OFF switch of warning device 30 is positioned at the ON state. The alarm signal then is delivered to ask for help to people around the building.

Accordingly, the safety belt device in accordance with the present invention includes a warning device for automatically generating warning signals to ask help from others when accidents happened.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A safety belt device having warning device, comprising:
a belt body;
a first fastener member connects to one end of said belt body;
a buffer device having a plurality of buffer units continuously connect and bend at the ends, so that the buffer units can be peeled one piece after another to obtain extended one, wherein the first buffer unit is connected to another end of said belt body, while the last buffer unit is connected to a second fastener member;
a warning devices connected to the surface of said belt body and capable of delivering alarm light and/or alarm sound, a ON/OFF rocket is formed at its one side for the end of a metallic actuator pin to insert in, another end of said metallic actuator pin is connected to a pulling rope, another end of said pulling rope is connected to said buffer device, so that when the buffer units of buffer device begins to peel, the automatic switch inside the warning device switches to ON state and the warning signals are delivered.

2. A safety belt device as claimed in claim 1, wherein when said first buffer unit begins to peel the buffer device, said metallic actuator member shall be pulled and separates away from the ON/OFF rocket, then the warning device is initiated to deliver warning signals.

3. A safety belt device as claimed in claim 1, wherein said buffer device uses the last buffer unit to fix one end of said pulling rope.

4. A safety belt device as claimed in claim 1, wherein the warning device has a manual switch.
